(19) United States
(12) Patent Application Publication
(10) Pub. No.: US 2026/0130430 A1
(43) Pub. Date: May 14, 2026

(54) HEATER PROVIDED IN AEROSOL-GENERATING DEVICE, METHOD OF MANUFACTURING THE SAME, AND AEROSOL-GENERATING DEVICE INCLUDING THE SAME

(71) Applicant: KT&G CORPORATION, Daejeon (KR)

(72) Inventors: Jangwon SEO, Yongin-si (KR); Jung Ho KIM, Seoul (KR); Sang Cheol PARK, Suwon-si (KR); Wonkyeong LEE, Guri-si (KR); Chul Ho JANG, Bucheon-si (KR); Jinchul JUNG, Daejeon (KR)

(73) Assignee: KT&G CORPORATION, Daejeon (KR)

(21) Appl. No.: 19/311,300

(22) Filed: Aug. 27, 2025

(30) Foreign Application Priority Data
Nov. 13, 2024 (KR) 10-2024-0160783
Feb. 5, 2025 (KR) 10-2025-0014481

(51) Int. Cl. A24F 40/465; A24F 40/57; A24F 40/70; H05B 3/42

(52) U.S. Cl. CPC A24F 40/465; A24F 40/57; A24F 40/70; H05B 3/42; H05B 2203/016; H05B 2203/017

(57) ABSTRACT

A heater provided in an aerosol-generating device includes a hollow pipe extending in one direction, and a fixed pipe surrounding at least a portion of the hollow pipe, wherein the hollow pipe and the fixed pipe are coupled to each other by an insulating adhesive.

### CROSS-REFERENCE TO RELATED APPLICATION

This application claims the benefit of Korean Patent Application No. 10-2024-0160783 filed on Nov. 13, 2024, and Korean Patent Application No. 10-2025-0014481 filed on Feb. 5, 2025, in the Korean Intellectual Property Office, the entire disclosure of which is incorporated herein by reference for all purposes.

### BACKGROUND

### 1. Field of the Invention

Various embodiments disclosed herein relate to a heater provided in an aerosol-generating device, a method of manufacturing the same, and an aerosol-generating device including the same.

### 2. Description of the Related Art

An aerosol-generating device is a technique for converting a liquid or solid aerosol-generating article into vapor by heating the aerosol-generating article and allowing a user to inhale the vapor and is used in various applications, such as an electronic cigarette and a heating device. A conventional aerosol-generating device needs improvements in heating efficiency, uniformity, energy consumption, and device life, and to resolve such issues, the demand for a new structure and manufacturing method has increased. For example, Korean Patent Publication No. 10-2021-0103858 discloses an aerosol-generating device and an aerosol-generating system.

The above description is information the inventor(s) acquired during the course of conceiving the present disclosure, or already possessed at the time, and is not necessarily art publicly known before the present application was filed.

### SUMMARY

An embodiment is to provide a heater provided in an aerosol-generating device bonded by an insulating adhesive.

An embodiment is to provide a method of manufacturing a heater provided in an aerosol-generating device bonded by an insulating adhesive.

An embodiment is to provide an aerosol-generating device including a heater bonded by an insulating adhesive.

A heater provided in an aerosol-generating device according to an embodiment includes a hollow pipe extending in one direction, and a fixed pipe surrounding at least a portion of the hollow pipe, wherein the hollow pipe and the fixed pipe are coupled to each other by an insulating adhesive.

In an embodiment, the insulating adhesive includes a ceramic-based material.

In an embodiment, the hollow pipe includes a plurality of slits disposed in parallel, a body on which the plurality of slits is disposed, and a protrusion extending from the body in at least one of the one direction and the other direction opposite to the one direction.

In an embodiment, the heater further includes a conducting wire connected to the hollow pipe, wherein the fixed pipe includes an opening, and the conducting wire is connected to the hollow pipe through the opening.

In an embodiment, the heater further includes an insulating pipe surrounding at least a portion of the fixed pipe and spaced apart from the fixed pipe by a gap.

In an embodiment, the insulating pipe includes a vacuum space.

In an embodiment, the fixed pipe includes an electrically resistive material.

A method of manufacturing a heater provided in an aerosol-generating device according to an embodiment includes providing a hollow pipe extending in one direction, applying an insulating adhesive to the hollow pipe, processing the hollow pipe, and assembling a fixed pipe with the hollow pipe.

In an embodiment, in the providing of the hollow pipe, the hollow pipe is provided to include a plurality of slits disposed in parallel, a body on which the plurality of slits is disposed, and a protrusion extending from the body in at least one of the one direction and the other direction opposite to the one direction, and after assembling the fixed pipe with the hollow pipe, the method further includes removing at least a portion of the protrusion of the hollow pipe.

In an embodiment, in the providing of the hollow pipe, the hollow pipe is provided to be cut to include a plurality of slits disposed in parallel and a protrusion extending in at least one of the one direction and the other direction opposite to the one direction from a body on which the plurality of slits is disposed.

In an embodiment, in the processing of the hollow pipe, the hollow pipe is heat treated between 100 degrees Celsius and 1000 degrees Celsius.

In an embodiment, in the applying of the insulating adhesive to the hollow pipe, the insulating adhesive is applied to a partial area of the hollow pipe to form an uncoated area, the fixed pipe includes an opening, and the uncoated area and the opening are positioned to correspond to each other when assembling the fixed pipe with the hollow pipe, and after assembling the fixed pipe with the hollow pipe, the method further includes connecting a conducting wire to the uncoated area of the hollow pipe through the opening of the fixed pipe.

In an embodiment, after assembling the fixed pipe with the hollow pipe, the method further includes applying the insulating adhesive to the fixed pipe, and processing the hollow pipe and the fixed pipe.

In an embodiment, in the processing of the hollow pipe and the fixed pipe, the hollow pipe and the fixed pipe are heat treated between 100 degrees Celsius and 1000 degrees Celsius.

A heater provided in an aerosol-generating device according to an embodiment may be insulated and bonded by an insulating adhesive.

A heater bonded by an insulating adhesive may be manufactured using a method of manufacturing the heater provided in an aerosol-generating device according to an embodiment.

An aerosol-generating device according to an embodiment may include a heater that is insulated and bonded by an insulating adhesive.

The effects of a heater provided in aerosol-generating device and a method of manufacturing the same are not limited to the above-mentioned effects, and other unmentioned effects can be clearly understood from the above description by those having ordinary skill in the technical field to which the present disclosure pertains.

### BRIEF DESCRIPTION OF THE DRAWINGS

The foregoing and other aspects, features, and advantages of embodiments in the disclosure will be apparent from the following detailed description with reference to the accompanying drawings.

FIG. 1 is a block diagram of an aerosol-generating device according to an embodiment

FIG. 2 shows an aerosol-generating device according to an embodiment.

FIG. 3 shows a heater according to an embodiment.

FIG. 4 is an exploded view of a heater according to an embodiment.

FIGS. 5A, 5B, 5C, and 5D show a method of manufacturing a heater according to an embodiment.

FIG. 6 is a flowchart of a method of manufacturing a heater according to an embodiment.

### DETAILED DESCRIPTION

Hereinafter, the embodiments disclosed in the present specification will be described in detail with reference to the accompanying drawings. The same or similar elements are denoted by the same reference numerals even though they are depicted in different drawings, and redundant descriptions thereof will be omitted. With regard to the description of the drawings, similar reference numerals may be used to refer to similar or related elements.

In the following description, with respect to constituent elements used in the following description, the suffixes “module” and “unit” are used only in consideration of facilitation of description, and do not have mutually distinguished meanings or functions. As used herein, the suffix “module” or “unit” may include a unit implemented in hardware, software, or firmware, and may be used interchangeably with other terms, for example, “logic,” “logic block,” “part,” or “circuitry.” A “module” or a “unit” may be a single integral component, or a minimum unit or part thereof, adapted to perform one or more functions. For example, the “module” or the “unit” may be implemented in the form of an application-specific integrated circuit (ASIC).

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and spirit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

Embodiments as set forth herein may be implemented as software including one or more instructions that are stored in a storage medium (e.g., a memory 17) that is readable by a machine (e.g., an aerosol-generating device 1). For example, a processor (e.g., a controller 12) of the machine (e.g., the aerosol-generating device 1) may invoke at least one of the one or more instructions stored in the storage medium, and may execute the same. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

In the present disclosure, the directions of the aerosol-generating device 1 may be defined based on the orthogonal coordinate system. In the orthogonal coordinate system, the x-axis direction may be defined as a leftward-rightward direction of the aerosol-generating device 1. The y-axis direction may be defined as a forward-backward direction of the aerosol-generating device 1. The z-axis direction may be defined as an upward-downward direction of the aerosol-generating device 1.

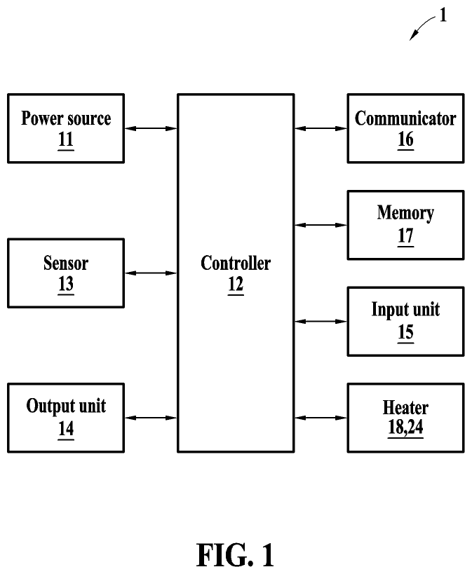

FIG. 1 is a block diagram of an aerosol-generating device according to an embodiment.

According to one embodiment, the aerosol-generating device 1 may include a power supply 11, a controller 12, a sensor unit 13, an output unit 14, an input unit 15, a communication unit 16, a memory 17, and/or a heater 18 and 24. However, the components included in the aerosol-generating device 1 are not limited to those shown in FIG. 1. That is, it will be understood by those skilled in the art related to the present embodiment that some of the components shown in FIG. 1 may be omitted or new components may be further included depending on the design of the aerosol-generating device 1.

According to one embodiment, the sensor unit 13 may detect the state of the aerosol-generating device 1 or the state of the surroundings of the aerosol-generating device 1, and may transmit the detected information to the controller 12. For example, the sensor unit 13 may include a temperature sensor, a puff sensor, an insertion detection sensor, a reuse detection sensor, an overly moist state detection sensor, a cigarette identification sensor, a cartridge detection sensor, a cap detection sensor, and/or a movement detection sensor. Meanwhile, the sensor unit 13 may further include various sensors, such as a liquid residual quantity sensor for detecting the residual quantity of liquid in the cartridge and an immersion sensor for detecting immersion of the aerosol-generating device 1.

According to one embodiment, the temperature sensor may detect a temperature to which the heater 18 and 24 is heated. The aerosol-generating device 1 may include a separate temperature sensor for detecting the temperature of the heater 18 and 24, or the heater 18 and 24 itself may serve as a temperature sensor. In an example, the temperature sensor may be used to measure impedance for the heater 18. The impedance for the heater 18 may correlate with the temperature of the heater 18. The temperature sensor may measure current and/or voltage applied to the heater 18 (or an induction coil). The impedance for the heater 18 may be obtained based on the measured current and/or voltage. The controller 12 may estimate the temperature of the heater 18 based on the obtained impedance.

In an example, the temperature sensor may include a resistance element (e.g., a thermistor), the resistance value of which varies in response to changes in the temperature of the heater 18 and 24. The temperature sensor may output a signal corresponding to the resistance value of the resistance element, and the controller 12 may determine the temperature of the heater 18 and 24 and/or a change in the temperature of the heater 18 and 24 based on the signal corresponding to the resistance value.

In another example, the temperature sensor may include a sensor that detects the resistance value of the heater 18 and 24. The temperature sensor may output a signal corresponding to the resistance value of the heater 18 and 24, and the controller 12 may determine the temperature of the heater 18 and 24 and/or a change in the temperature of the heater 18 and 24 based on the signal corresponding to the resistance value.

According to one embodiment, the temperature sensor may detect the temperature of the power supply 11. The temperature sensor may be disposed adjacent to the power supply 11. For example, the temperature sensor may be attached to one surface of the power supply 11 (e.g., a battery) and/or may be mounted on one surface of a printed circuit board. In an example, the aerosol-generating device 1 may include a power supply protection circuit module (PCM), and the temperature sensor may be disposed adjacent to the power supply 11 together with the power supply protection circuit module.

According to one embodiment, the temperature sensor may be disposed in a housing (not shown) of the aerosol-generating device 1 to detect the internal temperature of the housing (not shown).

According to one embodiment, the puff sensor may detect a user's puff.

In an example, the puff sensor may include a pressure sensor. The pressure sensor may output a signal corresponding to the internal pressure of the aerosol-generating device 1, and the controller 12 may determine the user's puff based on the signal corresponding to the internal pressure. Here, the internal pressure of the aerosol-generating device 1 may correspond to the pressure of an airflow path through which gas flows. The puff sensor may be disposed corresponding to the airflow path through which gas flows in the aerosol-generating device 1.

In another example, the puff sensor may include a temperature sensor. When the user's puff occurs, temperature drop may temporarily occur in the airflow path, a space into which an aerosol-generating article is inserted (hereinafter referred to as an “insertion space”), and the heater 18 and 24. The controller 12 may determine the user's puff based on a signal corresponding to the temperature of the airflow path output from the temperature sensor.

In still another example, the puff sensor may include both a pressure sensor and a temperature sensor. In this case, the temperature sensor may measure temperature used to calibrate the internal pressure measured by the pressure sensor. In one example, the puff sensor may calibrate a signal corresponding to the internal pressure based on the temperature measured by the temperature sensor, and may output the calibrated signal. In another example, the puff sensor may output a signal corresponding to the temperature measured by the temperature sensor and a signal corresponding to the internal pressure measured by the puff sensor. In this case, the controller 12 may receive the signals, and may calibrate the signal corresponding to the internal pressure based on the signal corresponding to the temperature.

In still another example, the puff sensor may include a capacitance sensor. The capacitance sensor may also be called a cap sensor or a capacitive sensor. When the user's puff occurs, a temperature change and/or aerosol flow may occur in the insertion space of the aerosol-generating article, and accordingly, a dielectric constant in the insertion space may change. The controller 12 may determine the user's puff based on a signal corresponding to the dielectric constant in the insertion space output from the capacitance sensor.

The puff sensor is not limited to the examples described above, and may be implemented as various sensors for detecting the user's puff.

According to one embodiment, the insertion detection sensor may detect insertion and/or removal of the aerosol-generating article. The insertion detection sensor may be mounted adjacent to the insertion space. In addition, the insertion detection sensor may include any combination of the examples described above.

In an example, the insertion detection sensor may include a capacitance sensor. The capacitance sensor may include at least one conductor, and the at least one conductor may be disposed adjacent to the insertion space. When the aerosol-generating article is inserted into or removed from the insertion space, capacitance around the conductor may change. The controller 12 may determine insertion and/or removal of the aerosol-generating article based on a signal corresponding to the dielectric constant in the insertion space output from the capacitance sensor.

In another example, the insertion detection sensor may include an inductive sensor. The inductive sensor may include at least one coil, and the at least one coil may be disposed adjacent to the insertion space. If the aerosol-generating article (e.g., a wrapper of the aerosol-generating article) includes a conductor, when the aerosol-generating article is inserted into or removed from the insertion space, a change in magnetic field may occur around the coil through which current flows. The controller 12 may determine insertion and/or removal of the aerosol-generating article including a conductor based on the characteristics of the current output from or detected by the inductive sensor (e.g., frequency of alternating current, a current value, a voltage value, an inductance value, and an impedance value). Alternatively, a susceptor SUS or the like may be included in the aerosol-generating article (e.g., a medium portion of the aerosol-generating article). In this case, a change in magnetic field may also occur around the coil based on insertion or removal of the susceptor or the like into or from the insertion space, and the controller 12 may determine insertion and/or removal of the aerosol-generating article based on the characteristics of the current of the inductive sensor.

The insertion detection sensor is not limited to the examples described above, and may be implemented as various sensors (e.g., a proximity sensor) for detecting insertion and/or removal of the aerosol-generating article. In addition, the insertion detection sensor may include any combination of the examples described above. According to one embodiment, the insertion detection sensor may include a switch or the like for detecting pressing by the aerosol-generating article.

According to one embodiment, the reuse detection sensor may detect whether the aerosol-generating article is being reused. In an example, the reuse detection sensor may be a color sensor for detecting the color of the aerosol-generating article. If the aerosol-generating article is used by the user, a change in the color of a portion of the wrapper may occur due to the generated aerosol or heating. The color sensor may output a signal corresponding to an optical characteristic (e.g., wavelength of light) corresponding to the color of the wrapper based on the light reflected from the wrapper. When a change in the color of a portion of the wrapper is detected, the controller 12 may determine that the aerosol-generating article inserted into the insertion space has already been used.

According to one embodiment, the overly moist state detection sensor may detect whether the aerosol-generating article is in an overly moist state. For example, the overly moist state detection sensor may include a capacitance sensor. The capacitance sensor may include at least one conductor disposed adjacent to the insertion space. The controller 12 may determine whether the aerosol-generating article is in an overly moist state based on the level of a signal corresponding to the dielectric constant or the like output from the capacitance sensor. In an example, the controller 12 may check a level range within which the level of the signal is included based on a look-up table, and may determine the moisture content of the aerosol-generating article based on the checked level range.

According to one embodiment, the cigarette identification sensor may detect whether the aerosol-generating article is authentic and/or may detect the type of the aerosol-generating article.

In an example, the cigarette identification sensor may include an optical sensor for detecting an identification material (or an identification mark) located on the outer surface (e.g., the wrapper) of the aerosol-generating article. The optical sensor may radiate light toward the identification material (or the identification mark) of the aerosol-generating article, and may detect whether the aerosol-generating article is authentic and/or may detect the type of the aerosol-generating article based on the reflected light. For example, the identification material may include a material (i.e., a luminous material) that emits light of a specific wavelength band based on the light radiated thereto. The controller 12 may determine whether the aerosol-generating article is authentic and/or may determine the type of the aerosol-generating article based on the range of the wavelength.

In another example, the cigarette identification sensor may include a capacitance sensor. The dielectric constant in the insertion space may vary depending on the type of the aerosol-generating article inserted into the insertion space. The controller 12 may determine whether the aerosol-generating article is authentic and/or may determine the type of the aerosol-generating article based on a signal corresponding to the dielectric constant or the like in the insertion space output from the capacitance sensor.

In still another example, the cigarette identification sensor may include an inductive sensor. If a conductor is included in the wrapper and/or inner portion (e.g., the medium portion) of the aerosol-generating article inserted into the insertion space, when the aerosol-generating article is inserted into the insertion space, the characteristics of the current detected by the inductive sensor (e.g., frequency of alternating current, a current value, a voltage value, an inductance value, and an impedance value) may vary depending on the type of the aerosol-generating article inserted into the insertion space. The controller 12 may determine whether the inserted aerosol-generating article is authentic and/or may determine the type of the inserted aerosol-generating article based on the characteristics of the current output from or detected by the inductive sensor.

The cigarette identification sensor is not limited to the examples described above, and may be implemented as various sensors for detecting whether the aerosol-generating article is authentic and/or detecting the type of the aerosol-generating article. In addition, the cigarette identification sensor may include any combination of the examples described above.

According to one embodiment, the cartridge detection sensor may detect mounting and/or removal of the cartridge. For example, the cartridge detection sensor may include an inductive sensor, a capacitance sensor, a resistance sensor, a Hall sensor (Hall IC), and/or an optical sensor.

According to one embodiment, the cap detection sensor may detect mounting and/or removal of the cap. For example, the cap detection sensor may include an inductive sensor, a capacitance sensor, a resistance sensor, a contact sensor, a Hall sensor (Hall IC), and/or an optical sensor. The cap may cover at least a portion of the cartridge mounted in or inserted into the aerosol-generating device 1 or may cover at least a portion of the housing of the aerosol-generating device 1. When the cap is mounted in or removed from the housing, the cap detection sensor may output a signal corresponding to mounting or removal, and the controller 12 may determine mounting or removal of the cap based on the signal corresponding to mounting or removal.

According to one embodiment, the movement detection sensor may detect movement of the aerosol-generating device 1. The movement detection sensor may be implemented as at least one of an acceleration sensor or a gyro sensor.

According to one embodiment, the sensor unit 13 may further include at least one of a humidity sensor, an air pressure sensor, a magnetic sensor, a position sensor (global positioning system (GPS)), or a proximity sensor in addition to the sensors described above. The functions of the sensors can be intuitively deduced by those skilled in the art from the names thereof, and thus detailed descriptions thereof may be omitted.

According to one embodiment, the output unit 14 may output information about the state of the aerosol-generating device 1 to provide the same to the user. The output unit 14 may include, but is not limited to, a display, a haptic unit, and/or a sound output unit. For example, information about the aerosol-generating device 1 may include a charging/discharging state of the power supply 11 of the aerosol-generating device 1, a preheating state of the heater 18 and 24, an insertion/removal state of the aerosol-generating article and/or the cartridge, a mounting/removal state of the cap, or a state in which the use of the aerosol-generating device 1 is restricted (e.g., detection of an abnormal object). The display may visually provide the information about the state of the aerosol-generating device 1 to the user. For example, the display may include a light-emitting diode (LED), a liquid crystal display panel (LCD), and an organic light-emitting diode panel (OLED). If the display includes a touchpad, the display may also be used as the input unit 15. The haptic unit may haptically provide the information about the aerosol-generating device 1 to the user. For example, the haptic unit may include a vibration motor, a piezoelectric element, and an electrical stimulation device. The sound output unit may audibly provide the information about the aerosol-generating device 1 to the user. For example, the sound output unit may convert an electrical signal into an acoustic signal and may output the acoustic signal to the outside.

According to one embodiment, the power supply 11 may supply power used for operation of the aerosol-generating device 1. The power supply 11 may include one or more batteries. The power supply 11 may supply power so that the heater 18 and 24 is heated. In addition, the power supply 11 may supply power necessary for operation of the other components included in the aerosol-generating device 1, such as the controller 12, the sensor unit 13, the output unit 14, the input unit 15, the communication unit 16, and the memory 17. The power supply 11 may be a rechargeable battery or a disposable battery. For example, the power supply 11 may be a lithium polymer (LiPoly) battery without being limited thereto. The power supply 11 may be a replaceable (separation-type) battery (hereinafter referred to as a “removable battery”). The removable battery may be mounted in a battery accommodation portion provided in the aerosol-generating device 1 or may be removed from the battery accommodation portion. The removable battery may be charged in a wired and/or wireless manner.

According to one embodiment, the heater 18 and 24 may receive power from the power supply 11 to heat the aerosol-generating article (e.g., a cigarette) and/or a medium and/or an aerosol-generating substance in the cartridge. The aerosol-generating device 1 may include a heater 18 for heating the aerosol-generating article and/or a cartridge heater 24 for heating the cartridge (i.e., a solid and/or liquid medium).

According to one embodiment, the heater 18 and 24 may be an electro-resistive heater. For example, the electro-resistive heater may include an electrically resistive material such as a metal or a metal alloy including titanium, zirconium, tantalum, platinum, nickel, cobalt, chromium, hafnium, niobium, molybdenum, tungsten, tin, gallium, manganese, iron, copper, stainless steel, and nichrome. The electro-resistive heater may be implemented as a metal wire, a metal plate having an electrically conductive track disposed thereon, or a ceramic heating element.

According to one embodiment, the heater 18 and 24 may be an induction heater. For example, the induction heater may include a susceptor that generates heat through a magnetic field. A magnetic field may be generated by an induction coil by alternating current flowing through the induction coil. The magnetic field may pass through the heater, and an eddy current may be generated in the susceptor. The susceptor may be heated based on generation of the eddy current. According to one embodiment, the susceptor may be included in the inner portion (e.g., the medium portion) of the aerosol-generating article. In this case, the susceptor included in the inner portion of the aerosol-generating article may also be heated by the induction coil.

The heater 18 and 24 is not limited to the examples described above, and may include or be replaced with various heating methods, structures, and components for heating the aerosol-generating article and/or the cartridge.

According to one embodiment, the input unit 15 may receive information input from the user. For example, the input unit 15 may include a touch panel, a button, a keypad, a dome switch, a jog wheel, and a jog switch.

According to one embodiment, the memory 17 may be hardware storing various pieces of data processed in the aerosol-generating device 1. The memory 17 may store data processed and to be processed by the controller 12. For example, the memory 17 may include at least one type of storage medium among a flash memory type memory, a hard disk type memory, a multimedia card micro type memory, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. For example, the memory 17 may store data on an operation time of the aerosol-generating device 1, the maximum number of puffs, the current number of puffs, at least one temperature profile, and the user's smoking pattern.

According to one embodiment, the communication unit 16 may include at least one component for communication with other electronic devices (e.g., a portable electronic device). For example, the communication unit 16 may include a Bluetooth communication unit, a Bluetooth low energy (BLE) communication unit, a near-field communication unit, a wireless local area network (WLAN) communication unit, a Zigbee communication unit, an infrared data association (IrDA) communication unit, a Wi-Fi direct (WFD) communication unit, an ultra-wideband (UWB) communication unit, an Ant+ communication unit, a cellular network communication unit, an Internet communication unit, and a computer network (e.g., LAN or WAN) communication unit.

According to one embodiment, the controller 12 may control the overall operation of the aerosol-generating device 1. For example, the controller 12 may include at least one processor. The controller 12 may be implemented as an array of a plurality of logic gates or may be implemented as a combination of a general-purpose microcontroller unit (MCU) (or a microprocessor) and a memory in which a program executable by the MCU is stored. It will be understood by those skilled in the art that the controller may also be implemented as other forms of hardware.

According to one embodiment, the controller 12 may control the supply of power from the power supply 11 to the heater 18 and 24 to control the temperature of the heater 18 and 24. The controller 12 may control the temperature of the heater 18 and 24 and/or power supplied to the heater 18 and 24 based on the temperature of the heater 18 and 24 detected by the temperature sensor (e.g., the sensor unit 13). The controller 12 may control the temperature of the heater 18 and 24 and/or power supplied to the heater 18 and 24 based on the temperature profile and/or the power profile stored in the memory 17.

According to one embodiment, the controller 12 may control a power conversion circuit (not shown) electrically connected to the heater 18 and 24 and the power supply 11 to control power (e.g., voltage and/or current) supplied to the heater 18 and 24. For example, the power conversion circuit may include a DC/DC converter (e.g., a buck converter, a buck-boost converter, a boost converter, or a Zener diode) that converts power to be supplied to the heater 18 and 24 and a DC/AC converter (e.g., an inverter) that converts power to be supplied to the induction coil (not shown). The DC/AC converter may be implemented as a full-bridge circuit or a half-bridge circuit including a plurality of switching elements. For example, the power conversion circuit may include at least one switching element, such as a bipolar junction transistor (BJT) or a field effect transistor (FET).

According to one embodiment, the controller 12 may control the frequency and/or duty ratio of a current pulse input to at least one switching element of the power conversion circuit (not shown) to control the current and/or the voltage supplied to the heater 18 and 24. The duty ratio for the on/off operation of the switching element may correspond to a ratio of the voltage output from the power conversion circuit to the voltage output from the power supply 11.

According to one embodiment, the controller 12 may control power supplied to the heater 18 and 24 using at least one of a pulse width modulation (PWM) scheme or a proportional-integral-differential (PID) scheme. For example, the controller 12 may perform control using the PWM scheme such that a current pulse having a predetermined frequency and a predetermined duty ratio is supplied to the heater 18 and 24. The controller 12 may control the frequency and duty ratio of the current pulse to control power supplied to the heater 18 and 24. For example, the controller 12 may determine, based on the temperature profile, a target temperature to be controlled. The controller 12 may control power supplied to the heater 18 and 24 using the PID scheme, which is a feedback control scheme using a difference value between the temperature of the heater 18 and the target temperature, a value obtained by integrating the difference value with respect to time, and a value obtained by differentiating the difference value with respect to time.

According to one embodiment, the controller 12 may determine, based on the power profile, target power to be controlled. The controller 12 may control power supplied to the heater 18 and 24 so as to correspond to the preset target power over time.

According to one embodiment, the controller 12 may detect power supplied to the heater 18 and 24 to determine the user's puff. In more detail, the controller 12 may control power supplied to the heater 18 and 24 using the proportional-integral-differential (PID) scheme. When the user's puff occurs, temperature drop may temporarily occur in a space into which the aerosol-generating article is inserted (hereinafter referred to as an insertion space) and the heater 18 and 24. Accordingly, the power (or the current) supplied to the heater 18 and 24 may change during control of the power using the PID scheme. The controller 12 may determine the user's puff based on the change in the power controlled.

According to one embodiment, the controller 12 may prevent the heater 18 and 24 from overheating. For example, the controller 12 may control, based on the temperature of the heater 18 and 24 exceeding a preset limit temperature, operation of the power conversion circuit such that the amount of power supplied to the heater 18 and 24 is reduced or the supply of power to the heater 18 and 24 is interrupted.

According to one embodiment, the controller 12 may control charging/discharging of the power supply 11. For example, the controller 12 may check the temperature of the power supply 11 using the temperature sensor (e.g., the sensor unit 13). If the temperature of the power supply 11 is equal to or higher than a first limit temperature, the controller 12 may interrupt charging of the power supply 11. If the temperature of the power supply 11 is equal to or higher than a second limit temperature, the controller 12 may interrupt use of the power stored in the power supply 11 (e.g., discharging). The controller 12 may calculate the remaining amount of the power stored in the power supply 11. For example, the controller 12 may calculate the remaining capacity of the power supply 11 based on a voltage and/or current detection value of the power supply 11.

According to one embodiment, the controller 12 may control the supply of power to the heater 18 and 24 based on a result of the detection by the sensor unit 13.

According to one embodiment, the controller 12 may control the supply of power to the heater 18 and 24 based on insertion and/or removal of the aerosol-generating article into and/or from the insertion space. For example, upon determining that the aerosol-generating article has been inserted into the insertion space using the insertion detection sensor (e.g., the sensor unit 13), the controller 12 may perform control such that power is supplied to the heater 18 and 24. Upon determining that the aerosol-generating article has been removed from the insertion space using the insertion detection sensor (e.g., the sensor unit 13), the controller 12 may interrupt the supply of power to the heater 18 and 24. The controller 12 may determine that the aerosol-generating article has been removed from the insertion space when the temperature of the heater 18 and 24 is equal to or higher than a limit temperature or when the temperature change slope of the heater 18 and 24 is equal to or greater than a preset slope.

According to one embodiment, the controller 12 may control, based on the state of the aerosol-generating article, a power supply time and/or the amount of power supplied to the heater 18 and 24. For example, upon determining that the aerosol-generating article is in an overly moist state using the overly moist state detection sensor (e.g., the sensor unit 13), the controller 12 may increase a time during which power is supplied to the heater 18 and 24 (e.g., a preheating time).

According to one embodiment, the controller 12 may control the supply of power to the heater 18 and 24 based on whether the aerosol-generating article is being reused. For example, upon determining that the aerosol-generating article has already been used, the controller 12 may interrupt the supply of power to the heater 18 and 24.

According to one embodiment, the controller 12 may control the supply of power to the heater 18 and 24 based on whether the cartridge has been coupled and/or removed. For example, upon determining that the cartridge has been removed using the cartridge detection sensor (e.g., the sensor unit 13), the controller 12 may interrupt the supply of power to the heater 18 or 24 or may perform control such that power is not supplied to the heater 18 and 24.

According to one embodiment, the controller 12 may control the supply of power to the heater 18 and 24 based on whether the aerosol-generating substance in the cartridge has been exhausted. For example, upon determining that the temperature of the heater 18 and 24 exceeds a limit temperature during preheating of the heater 18 and 24 (i.e., in the preheating section), the controller 12 may determine that the aerosol-generating substance in the cartridge has been exhausted. Upon determining that the aerosol-generating substance in the cartridge has been exhausted, the controller 12 may interrupt the supply of power to the heater 18 and 24.

According to one embodiment, the controller 12 may control the supply of power to the heater 18 and 24 based on whether use of the cartridge is possible. For example, upon determining, based on data stored in the memory 17, that the current number of puffs is equal to or greater than the maximum number of puffs set for the cartridge, the controller 12 may determine that use of the cartridge is impossible. Alternatively, when a total time period during which the heater 18 and 24 is heated is equal to or longer than a preset maximum time period or when the total amount of power supplied to the heater 18 and 24 is equal to or greater than a preset maximum amount of power, the controller 12 may determine that use of the cartridge is impossible. In this case, the controller 12 may interrupt the supply of power to the heater 18 or 24 or may perform control such that power is not supplied to the heater 18 and 24.

According to one embodiment, the controller 12 may control the supply of power to the heater 18 and 24 based on the user's puff. For example, the controller 12 may determine whether a puff occurs and/or the intensity of a puff using the puff sensor (e.g., the sensor unit 13). When the number of puffs reaches a preset maximum number of puffs and/or when no puff is detected for a preset time period or longer, the controller 12 may interrupt the supply of power to the heater 18 and 24. When a puff is detected, the controller 12 may control the supply of power to the heater 18 and 24.

According to one embodiment, the controller 12 may control the supply of power to the heater 18 and 24 based on whether the aerosol-generating article (or the cartridge) is authentic and/or the type of the aerosol-generating article (or the cartridge). For example, the controller 12 may determine whether the aerosol-generating article is authentic and/or may determine the type of the aerosol-generating article using the cigarette identification sensor (e.g., the sensor unit 13). In an example, upon determining that the aerosol-generating article (or the cartridge) is inauthentic, the controller 12 may interrupt the supply of power to the heater 18 and 24. Upon determining that the aerosol-generating article (or the cartridge) is authentic, the controller 12 may control (e.g., commence) the supply of power to the heater 18 and 24. In another example, the controller 12 may control the supply of power to the heater 18 and 24 differently depending on the type of the aerosol-generating article (or the cartridge). In more detail, upon determining that the aerosol-generating article (or the cartridge) is a first aerosol-generating article (or a first cartridge), the controller 12 may control the temperature of the heater 18 and 24 and/or power based on a first temperature profile (or a first power profile), and upon determining that the aerosol-generating article (or the cartridge) is a second aerosol-generating article (or a second cartridge), the controller 12 may control the temperature of the heater 18 and 24 and/or power based on a second temperature profile (or a second power profile).

According to one embodiment, the controller 12 may control the output unit 14 based on a result of detection by the sensor unit 13. For example, when the number of puffs counted using the puff sensor (e.g., the sensor unit 13) reaches a preset number, the controller 12 may control the output unit 14 to visually, haptically, and/or audibly provide information that operation of the aerosol-generating device 1 will end soon. For example, the controller 12 may control the output unit 14 to visually, haptically, and/or audibly provide information about the temperature of the heater 18 and 24.

According to one embodiment, based on occurrence of a predetermined event, the controller 12 may store a history of the corresponding event in the memory 17 and may update the history. For example, the event may include events performed in the aerosol-generating device 1, such as detection of insertion of the aerosol-generating article, commencement of heating of the aerosol-generating article, detection of puff, termination of puff, detection of overheating of the heater 18 and 24, detection of application of overvoltage to the heater 18 and 24, termination of heating of the aerosol-generating article, on/off operation of the aerosol-generating device 1, commencement of charging of the power supply 11, detection of overcharging of the power supply 11, and termination of charging of the power supply 11. For example, the history of the event may include the occurrence date and time of the event and log data corresponding to the event. For example, when the predetermined event is detection of insertion of the aerosol-generating article, the log data corresponding to the event may include data on a value detected by the insertion detection sensor (e.g., the sensor unit 13). For example, when the predetermined event is detection of overheating of the heater 18 and 24, the log data corresponding to the event may include data on the temperature of the heater 18 and 24, the voltage applied to the heater 18 and 24, and the current flowing through the heater 18 and 24.

According to one embodiment, the controller 12 may control the communication unit 16 to form a communication link with an external device such as a user's mobile terminal.

According to one embodiment, upon receiving data on authentication from an external device via the communication link, the controller 12 may release restriction on use of at least one function (e.g., a heating function) of the aerosol-generating device 1. For example, the data on authentication may include the user's birthday, an identification number uniquely identifying the user, and whether authentication is completed by the user.

According to one embodiment, the controller 12 may transmit data on the state of the aerosol-generating device 1 (e.g., remaining capacity of the power supply 11 and operation mode) to the external device via the communication link. The transmitted data may be output through a display or the like of the external device.

According to one embodiment, upon receiving a request to search for the location of the aerosol-generating device 1 from the external device via the communication link, the controller 12 may control the output unit 14 to perform an operation corresponding to location search. For example, the controller 12 may perform control such that the haptic unit generates vibration or the display outputs objects corresponding to location search and termination of search.

According to one embodiment, upon receiving firmware data from the external device via the communication link, the controller 12 may perform firmware update.

According to one embodiment, the controller 12 may transmit data on a value detected by the at least one sensor unit 13 to an external server (not shown) via the communication link, and may receive, from the server, and store a learning model generated by learning the detected value through machine learning such as deep learning. The controller 12 may perform the operation of determining the user's puff pattern and the operation of generating the temperature profile using the learning model received from the server.

Although not shown in FIG. 1, the aerosol-generating device 1 may further include a power supply protection circuit. The power supply protection circuit may include at least one switching element, and may block an electric path to the power supply 11 in response to overcharging and/or overdischarging of the power supply 11. The aerosol-generating device 1 may further include a connection interface such as a universal serial bus (USB) interface, and may be connected to other external devices through the connection interface to transmit and receive information or charge the power supply 11.

The aerosol-generating article mentioned in the present disclosure may include at least one aerosol-generating rod (e.g., a medium portion) and at least one filter rod. The heater 18 may be disposed to correspond to the at least one aerosol-generating rod, and may be designed differently depending on the arrangement order and/or positions of the aerosol-generating rod and the filter rod. The aerosol-generating rod may contain at least one of nicotine, an aerosol-generating substance, and an additive. For example, the aerosol-generating substance may include glycerin (e.g., vegetable glycerin (VG)) and/or propylene glycol (PG) and may also include various other substances. For example, the additive may include a flavoring agent and/or an organic acid and may also include various other substances. For example, the aerosol-generating rod may include an aerosol-generating substrate (e.g., a sheet) impregnated with a liquid non-tobacco substance (e.g., an aerosol-generating substance and/or nicotine) and/or may contain a solid tobacco substance (e.g., leaf tobacco and reconstituted tobacco). The tobacco substance may be contained in the aerosol-generating rod in various forms, such as shredded tobacco, granules, and powder. According to one embodiment, the additive of the aerosol-generating rod may include an alkaline substance. Based on the alkaline substance, nicotine contained in the tobacco substance in the aerosol-generating rod may have an alkaline pH (e.g., pH 7.0 or higher). In this case, freebase nicotine may be released from the aerosol-generating rod even at a low temperature. According to one embodiment, the aerosol-generating rod may include two or more aerosol-generating rods, each of which may contain a tobacco substance and/or a non-tobacco substance. Meanwhile, although not shown, the at least one aerosol-generating rod and the at least one filter rod may individually and/or integrally be wrapped by at least one wrapper. In the present disclosure, the aerosol-generating article may be referred to as a stick.

The cartridge mentioned in the present disclosure may contain an aerosol-generating substance having any one state among a liquid state, a solid state, a gaseous state, and a gel state. The aerosol-generating substance may include a liquid composition. For example, the liquid composition may be a liquid containing a tobacco-containing substance including a volatile tobacco flavor component or may be a liquid containing a non-tobacco substance. Meanwhile, the cartridge may include a storage part that contains the aerosol-generating substance and/or a liquid delivery part that is impregnated with (contains) the aerosol-generating substance. For example, the liquid delivery part may include a wick formed of, e.g., cotton fiber, ceramic fiber, glass fiber, or porous ceramic. The cartridge heater 24 may be included in the cartridge in a coil-shaped structure surrounding (or wound around) the liquid delivery part or a structure contacting one side of the liquid delivery part. Alternatively, the cartridge heater 24 may be included in the aerosol-generating device 1, which is removable from the cartridge.

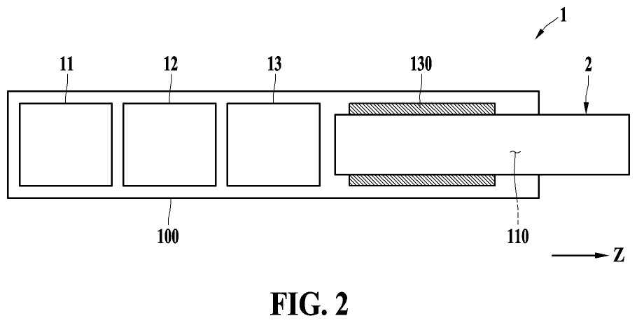

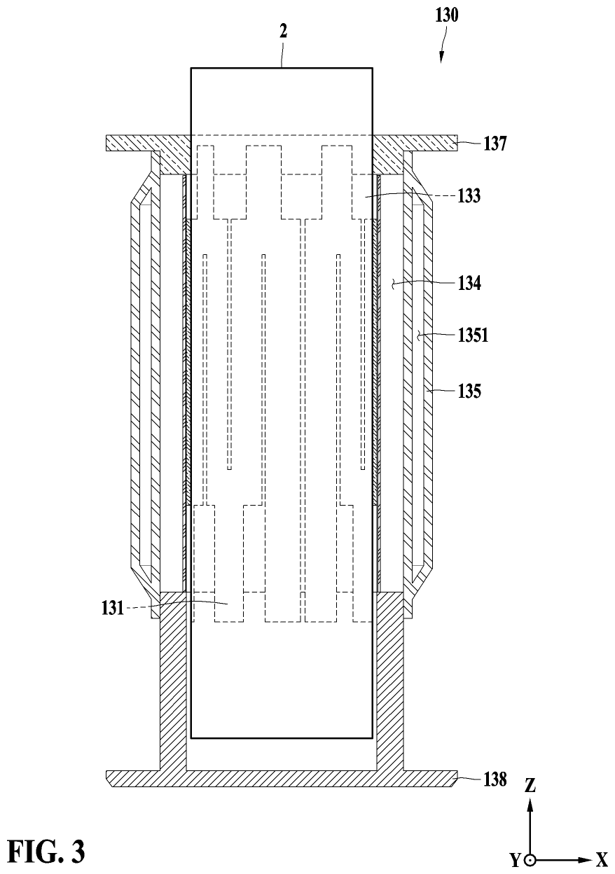

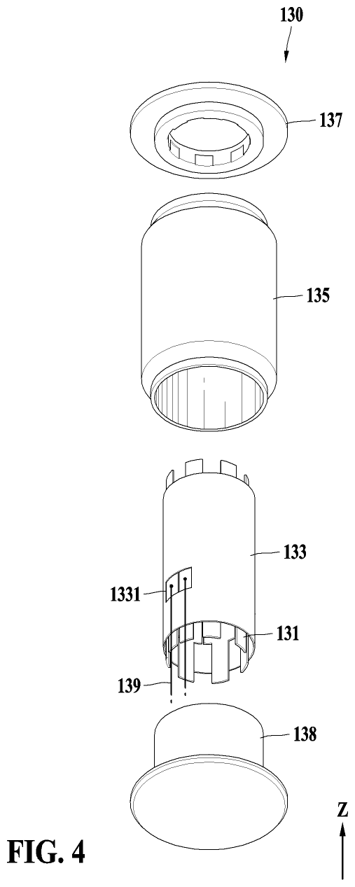

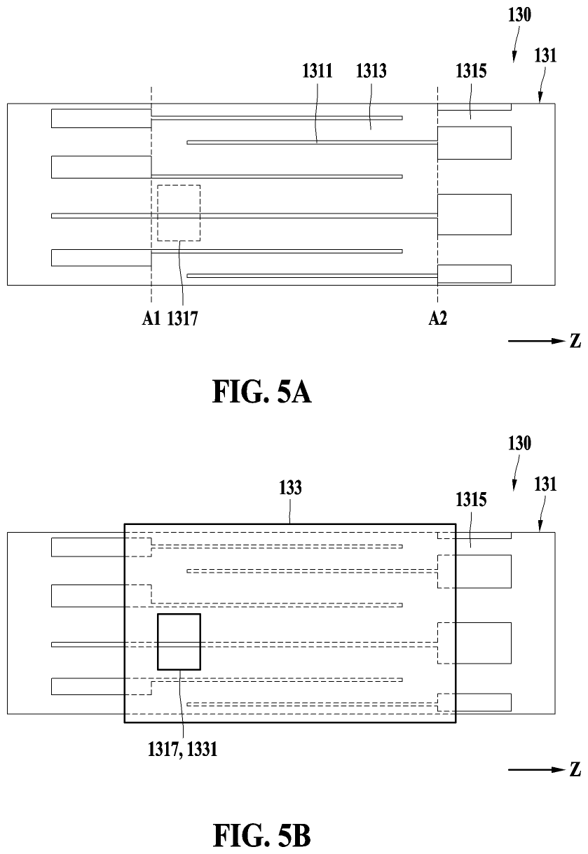

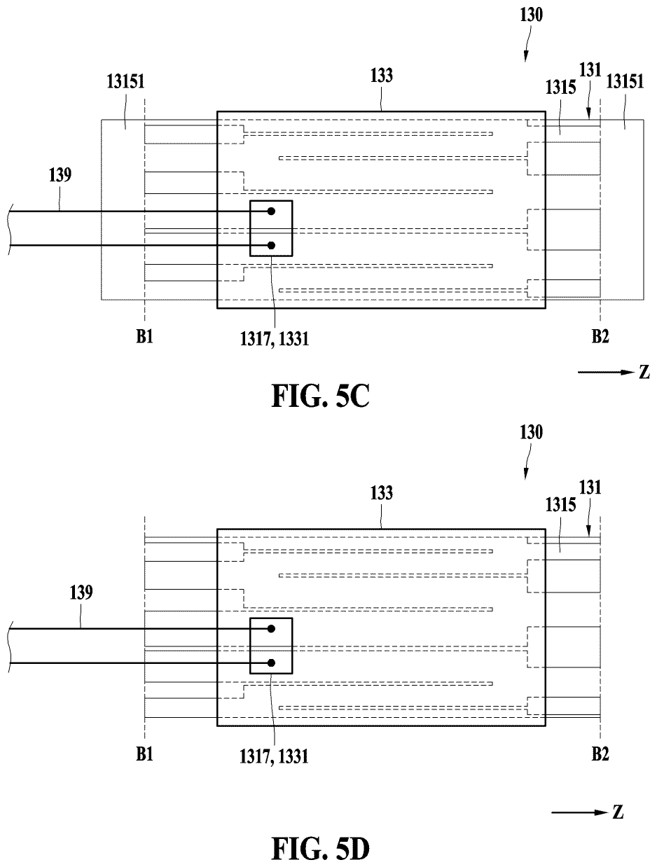

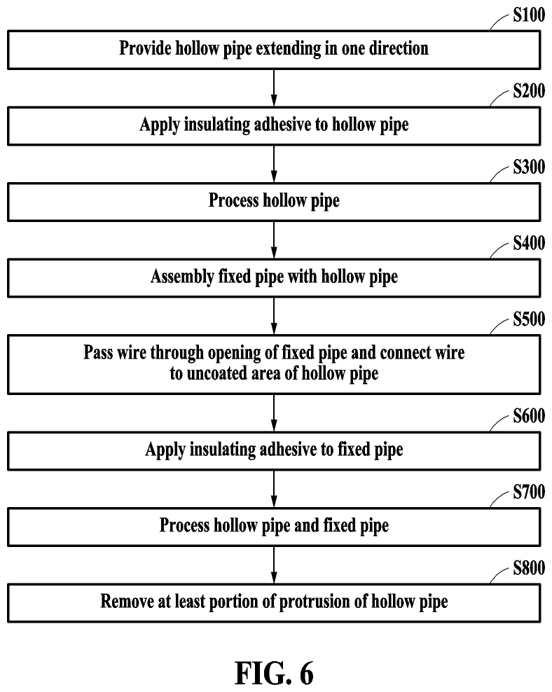

FIG. 2 shows an aerosol-generating device according to an embodiment. FIG. 3 shows a heater according to an embodiment. FIG. 4 is an exploded view of a heater according to an embodiment. FIGS. 5A, 5B, 5C, and 5D show a method of manufacturing a heater according to an embodiment. FIG. 6 is a flowchart of a method of manufacturing a heater according to an embodiment.

Referring to FIG. 2, the aerosol-generating device 1 may include a housing 100, the power supply 11, the controller 12, the sensor unit 13, and a heater 130 (e.g., the heater 18 of FIG. 1). However, those skilled in the art related to the present embodiment may understand that some of the components included in the aerosol-generating device 1 may be omitted or an additional component may be added to the aerosol-generating device 1, without being limited to the components shown in FIG. 2. The aerosol-generating device 1 shown in FIG. 2 may be referred to as an “external heating-type” aerosol-generating device that heats the outer side of an aerosol-generating article 2. Hereinafter, in the drawings, a repeated description of FIG. 1 is omitted.

According to one embodiment, the housing 100 may provide a space that is open in one direction (e.g., the −Z direction) to insert the aerosol-generating article 2 therein. In the present disclosure, the space that is open in one direction may also be referred to as an insertion space 110. The insertion space 110 may be recessed by a predetermined depth toward the inside of the housing 100 to insert at least a portion of the aerosol-generating article 2 therein. The depth of the insertion space 110 may be greater than or equal to the length of an area in which an aerosol-generating article and/or medium is included in the aerosol-generating article 2. The lower end of the aerosol-generating article 2 may be inserted into the housing 100, and the upper end of the aerosol-generating article 2 may protrude outside the housing 100. A user may inhale an aerosol by biting the upper end of the aerosol-generating article 2 that is exposed to the outside.

According to one embodiment, the heater 130 may heat the aerosol-generating article 2.

According to one embodiment, the heater 130 may be an external heating-type heater. The heater 130 may heat the outer side of the aerosol-generating article 2 inserted into the insertion space 110.

According to one embodiment, the heater 130 may be an electrical resistive heater. For example, the electrical resistive heater may include an electrically resistive material in the inside (e.g., an internal cavity or an inner surface) or the outside (e.g., an outer surface) of the electrical resistive heater and may be heated as a current flows through the electrically resistive material. In this case, the electrical resistance heater may be electrically connected to the power supply 11 and may be directly heated by receiving the current from the power supply 11.

According to one embodiment, the heater 130 may be disposed inside the housing 100. The heater 130 may longitudinally extend in one direction around a space (in other words, the insertion space 110) in which the aerosol-generating article 2 is inserted and which is the inside of the housing 100. For example, the heater 130 may be disposed to surround at least a portion of the insertion space 110.

According to one embodiment, an airflow channel (not shown) through which air flows may be provided in the aerosol-generating device 1. For example, the housing 100 may include a structure (e.g., a hole) to introduce air into the housing 100 from the outside. The air introduced into the housing 100 may be introduced into the aerosol-generating article 2 via the lower end (in other words, an upstream side) of the aerosol-generating article 2. The aerosol generated by heating the aerosol-generating article 2 may be inhaled into the user's mouth via the upper end (in other words, a downstream side) of the aerosol-generating article 2 together with the introduced air.

Referring to FIGS. 3 and 4, the heater 130 according to an embodiment may include a hollow pipe 131, a fixed pipe 133, and an insulating pipe 135.

According to one embodiment, the hollow pipe 131 may extend in one direction (e.g., the-Z direction). For example, the hollow pipe 131 may be disposed to surround at least a portion of the insertion space 110. When inserting the aerosol-generating article 2, the hollow pipe 131 may surround at least a portion of the aerosol-generating article 2.

According to one embodiment, the inner diameter of the hollow pipe 131 may be greater than the outer diameter of the aerosol-generating article 2.

According to one embodiment, the hollow pipe 131 may include an electrically resistive material, such as metal or metal alloy including titanium, zirconium, tantalum, platinum, nickel, cobalt, chromium, hafnium, niobium, molybdenum, tungsten, tin, gallium, manganese, iron, cobalt, stainless steel, and nichrome. Specifically, the hollow pipe 131 may include an electrically resistive material including stainless steel.

According to one embodiment, as described above, the heater 130 may be an electrical resistive heater, and the hollow pipe 131 may function as a heating element, such as a metal heating wire of the electrical resistive heater or a metal heating plate on which an electrically conductive track is disposed.

According to one embodiment, the fixed pipe 133 may extend in one direction (e.g., the −Z direction) and may be a hollow cylindrical pipe. For example, on the outside of the circumference of the hollow pipe 131, the fixed pipe 133 may be disposed to surround at least a portion of the hollow pipe 131. For example, the fixed pipe 133 may be disposed to surround a portion other than the upper and lower end portions of the hollow pipe 131. Although not shown in the drawings, the fixed pipe 133 may be disposed to surround the remaining portion other than one of the upper end portion and the lower end portion of the hollow pipe 131.

According to one embodiment, the hollow pipe 131 may be fitted into the fixed pipe 133, and in this case, the inner diameter of the fixed pipe 133 may be greater than the outer diameter of the hollow pipe 131.

According to one embodiment, the fixed pipe 133 may surround at least a portion of a body 1313 and a protrusion 1315 of the hollow pipe. The body 1313 and the protrusion 1315 are described below with reference to FIG. 5A.

According to one embodiment, the fixed pipe 133 may include an opening 1331. The opening 1331 may be formed on a side surface of the fixed pipe 133. The side surface of the fixed pipe 133 may refer to a surface between a bottom surface as an end portion in one direction of the fixed pipe 133 and a top surface as an end portion in the other direction.

According to one embodiment, the fixed pipe 133 may include an electrically resistive material, such as metal or metal alloy including titanium, zirconium, tantalum, platinum, nickel, cobalt, chromium, hafnium, niobium, molybdenum, tungsten, tin, gallium, manganese, iron, cobalt, stainless steel, and nichrome. Specifically, the fixed pipe 133 may include an electrically resistive material including stainless steel.

According to one embodiment, the fixed pipe 133 may be coupled to the hollow pipe 131. The fixed pipe 133 and the hollow pipe 131 may be insulated and coupled to each other by an insulating adhesive including a ceramic-based material. Even if the fixed pipe 133 includes an electrically resistive material (e.g., a metal material including stainless steel), since the fixed pipe 133 and the hollow pipe 131 are insulated from each other, an undesired current may not flow from the hollow pipe 131 to the fixed pipe 133.

The ceramic-based material used as the insulating adhesive may have excellent electrical insulation and heat resistance and may simultaneously perform mechanical coupling and electrical insulation between the hollow pipe 131 and the fixed pipe 133 by achieving physical and chemical stability through heat treatment. Typically, the adhesive may include ceramic powder (e.g., alumina, zirconia, or silica) and a binder (e.g., silicate or aluminum phosphate) that is stable even in high temperatures. Their combination may form a strong bonding layer during the heat treatment and may maintain stability even in a high-temperature environment, such as a heating element.

Alumina may be widely used as an insulating adhesive because of excellent electrical insulation and structural stability in high temperatures. Zirconia may further enhance the stability under high temperature and thermal shock conditions due to its excellent heat resistance and thermal shock stability. In addition, silica may have excellent heat resistance and insulation and may contribute to enhance a binding force together with silicate or phosphate used as a binder.

The heat treatment may change the adhesive to a solid ceramic layer through a gelation or sintering process, and the adhesive may provide excellent insulation and mechanical durability to a coupling portion between the hollow pipe 131 and the fixed pipe 133. In addition, the ceramic-based insulating adhesive may prevent current leakage between the hollow pipe 131 and the fixed pipe 133 and may minimize loss due to heat transfer.

A method of manufacturing a heater provided in an aerosol-generating device is described below with reference to FIGS. 5A, 5B, 5C, and 5D.

According to one embodiment, the heater 130 may further include a conducting wire 139. The conducting wire 139 may be connected to the hollow pipe 131 by passing through the opening 1331 of the fixed pipe. A power supply (e.g., the power supply 11 of FIG. 2) may supply power to the hollow pipe 131 via the conducting wire 139. The conducting wire 139 connected to the hollow pipe 131 through the opening 1331 may remain connected to the hollow pipe 131 without being easily separated from the hollow pipe 131 by a physical impact. Although not shown, the heater 130 may further include another conducting wire connected to the hollow pipe 131 that does not pass through the opening 1331.

According to one embodiment, the insulating pipe 135 may surround at least a portion of the hollow pipe 131. For example, on the outside of the circumference of the hollow pipe 131, the insulating pipe 135 may be disposed to surround at least a portion of the hollow pipe 131. For example, the insulating pipe 135 may be disposed to surround a portion other than the upper and lower end portions of the hollow pipe 131. Although not shown in the drawings, the insulating pipe 135 may be disposed to surround the remaining portion other than one of the upper end portion and the lower end portion of the hollow pipe 131.

According to one embodiment, the insulating pipe 135 may surround at least a portion of the fixed pipe 133. In this case, the fixed pipe 133 may be positioned between the insulating pipe 135 and the hollow pipe 131. For example, on the outside of the circumference of the fixed pipe 133, the insulating pipe 135 may be disposed to surround at least a portion of the fixed pipe 133. For example, the insulating pipe 135 may be disposed to surround the entire circumference of the fixed pipe 133.

According to one embodiment, the inner diameter of the insulating pipe 135 may be greater than the outer diameter of the fixed pipe 133.

According to one embodiment, the insulating pipe 135 may be spaced apart from the fixed pipe 133 by a gap 134. The gap 134 may be an air gap. The gap 134 may reduce heat transfer to the insulating pipe 135 from the hollow pipe 131 or the fixed pipe 133 functioning as a heating element.

According to one embodiment, the heater 130 may further include an upper cover 137 and a lower cover 138. The upper cover 137 and the lower cover 138 may include a cavity to insert the aerosol-generating article 2 therein. The inner diameters of the upper cover 137 and the lower cover 138 may be defined by the cavity. The upper cover 137 and the lower cover 138 may surround at least a portion of the insertion space 110. The gap 134 between the insulating pipe 135 and the fixed pipe 133 may be structurally maintained by the upper cover 137 and the lower cover 138. For example, the hollow pipe 131 coupled to the fixed pipe 133 may be fitted into the upper cover 137 and the lower cover 138.

According to one embodiment, the fixed pipe 133 may be positioned between the upper cover 137 and the lower cover 138. The upper cover 137 and the lower cover 138 may allow the hollow pipe 131 to be fitted but may not allow the fixed pipe 133 to be fitted. The inner diameters of the upper cover 137 and the lower cover 138, the outer diameter of the fixed pipe 133, or the outer diameter of the hollow pipe 131 may be set so that the upper cover 137 and the lower cover 138 allow the hollow pipe 131 to be fitted while preventing the fixed pipe 133 to be fitted. For example, the inner diameters of the upper cover 137 and the lower cover 138 may be greater than the outer diameter of the hollow pipe 131 and may be less than the outer diameter of the fixed pipe 133 surrounding the hollow pipe 131.

According to one embodiment, the insulating pipe 135 may surround at least a portion of the fixed pipe 133. For example, the insulating pipe 135 may surround the entire lateral direction (e.g., directions perpendicular to the +/-Z direction) of the fixed pipe 133.

According to one embodiment, the insulating pipe 135 may include a vacuum space 1351 inside the insulating pipe 135. The pressure of the vacuum space 1351 may be vacuum pressure. In this case, the vacuum pressure may refer to pressure below atmospheric pressure (760 Torr). The vacuum space 1351 may be low, medium, or high vacuum. In this case, low vacuum may refer to pressure greater than 10 Torr and less than or equal to 760 Torr, medium vacuum may refer to pressure greater than 0.001 Torr and less than or equal to 10 Torr, and high vacuum may refer to pressure greater than 0.0000001 Torr and less than or equal to 0.001 Torr. The vacuum space 1351 may increase the insulation effect of the insulating pipe 135. The vacuum space 1351 may reduce heat transfer to the insulating pipe 135 from the hollow pipe 131 or the fixed pipe 133 functioning as a heating element.

According to one embodiment, the upper cover 137 and the lower cover 138 may be fitted into the insulating pipe 135. Although not shown in the drawings, the insulating pipe 135 may be fitted into the upper cover 137 and the lower cover 138.

Referring to FIG. 5A, the hollow pipe 131 may include a slit 1311, the body 1313, and the protrusion 1315.

According to one embodiment, the slit 1311 may extend in one direction (e.g., the −Z direction) or the other direction (e.g., the +Z direction) opposite to the one direction. The slit 1311 may increase a path of the current flowing through the hollow pipe 131 and may help the hollow pipe 131 to better function as a heating element.

According to one embodiment, the hollow pipe 131 may include a plurality of slits 1311. The plurality of slits 1311 may be disposed in parallel. For example, a slit extending in one direction (e.g., the −Z direction) and a slit extending in the other direction may be alternately disposed. The slit indicated by reference number 1311 in FIG. 5A may be a slit extending in one direction, and two slits immediately next to the slit may be slits extending in the other direction. The slit 1311 may be disposed at an end portion of the body 1313 in which the protrusion 1315 to be described below does not extend.

According to one embodiment, the plurality of slits 1311 may be disposed on the body 1313. The slit 1311 may extend from an end portion of the body 1313 in one direction or the other direction.

According to one embodiment, the protrusion 1315 may extend from the body 1313 in at least one of the one direction and the other direction. In FIG. 5A, a boundary between the protrusion 1315 and the body 1313 is indicated by lines A1 and A2.

Hereinafter, referring to FIGS. 5A, 5B, 5C, and 5D, a method of manufacturing a heater provided in an aerosol-generating device is described.

Referring to FIG. 5A, according to an embodiment, the hollow pipe 131 extending in one direction may be provided.

According to one embodiment, the hollow pipe 131 may include the plurality of slits 1311 disposed in parallel, the body 1313 on which the plurality of slits is disposed, and the protrusion 1315 extending from the body in at least one of one direction (e.g., the −Z direction) and the other direction (e.g., the +Z direction) opposite to the one direction.

According to one embodiment, at least one of the plurality of slits 1311 and the protrusion 1315 of the hollow pipe 131 may be cut (e.g., laser cut). For example, the plurality of slits 1311 and the protrusion 1315 may be formed by removing a portion of a hollow cylindrical pipe by laser cutting the cylindrical pipe.

According to one embodiment, an insulating adhesive may be applied to the provided hollow pipe 131. The insulating adhesive may include a ceramic-based material.

According to one embodiment, the insulating adhesive may be applied to a partial area of the hollow pipe 131 to form an uncoated area 1317. The uncoated area 1317 may be implemented by masking a specific area on the hollow pipe 131 before applying the insulating adhesive. For example, the uncoated area 1317 may be implemented by taping a specific area of the hollow pipe 131 with masking tape.

According to one embodiment, the hollow pipe 131 to which the insulating adhesive is applied may be processed. For example, processing may be heat treatment. The heat treatment may be performed at a temperature between 100 degrees Celsius and 1000 degrees Celsius. The heat treatment may be performed at various temperatures by varying the temperature. The insulating adhesive may be deformed or hardened by the heat treatment to insulate the outer surface of the hollow pipe from other external elements.

Referring to FIG. 5B, the fixed pipe 133 may be assembled with the hollow pipe 131.

According to one embodiment, the opening 1331 of the fixed pipe may correspond to the uncoated area 1317 of the hollow pipe 131. In other words, the conducting wire 139 may approach the uncoated area 1317 of the hollow pipe 131 via the opening 1331.

Referring to FIG. 5C, according to an embodiment, the conducting wire 139 may be connected to the uncoated area 1317 of the hollow pipe by passing through the opening 1331 of the fixed pipe. Since the uncoated area 1317 is not insulated even after processing, the conducting wire may be connected. For example, the conducting wire may be connected to the uncoated area 1317 of the hollow pipe by spot welding. The conducting wire 139 may be electrically connected to the hollow pipe 131.

According to one embodiment, after connecting the conducting wire 139 to the uncoated area 1317 of the hollow pipe, the insulating adhesive may be applied to the fixed pipe 133. The insulating adhesive may be applied again to the hollow pipe 131 in addition to the fixed pipe 133, or the insulating adhesive may be selectively applied only to the fixed pipe 133 but not the hollow pipe 131.

According to one embodiment, after the insulating adhesive is applied to the fixed pipe 133, the hollow pipe 131 and the fixed pipe 133 may be processed. For example, processing may be heat treatment. The heat treatment may be performed at a temperature between 100 degrees Celsius and 1000 degrees Celsius. The heat treatment may be performed at various temperatures by varying the temperature. The insulating adhesive may be deformed or hardened by the heat treatment to insulate the hollow pipe 131 and the fixed pipe 133 from each other. In addition, the hollow pipe 131 and the fixed pipe 133 may be coupled to each other. The outer surface of the fixed pipe 133 may be insulated from other external elements. The hollow pipe 131 and the fixed pipe 133 may be insulated from other external elements other than the conducting wire 139 connected to the hollow pipe 131.

Referring to FIG. 5D, after the hollow pipe 131 and the fixed pipe 133 are processed, at least a portion of the protrusion 1315 of the hollow pipe may be removed. For example, an end portion of the protrusion in one direction (e.g., the −Z direction) and an end portion of the protrusion in the other direction (e.g., the +Z direction) may be removed. At least a portion of the protrusion 1315 may be removed using laser cutting. FIGS. 5A, 5B, and 5C show a portion of the protrusion 1315 to be removed. In FIGS. 5C and 5D, boundaries of the protrusion 1315 that is removed are indicated by lines B1 and B2. In FIG. 5C, a portion of the protrusion 1315 to be removed is indicated by reference number 13151. On the other hand, FIG. 5D does not show the removed portion.

Referring to FIG. 6, a method of manufacturing a heater provided in an aerosol-generating device may include a step S100 of providing the hollow pipe 131 extending in one direction, a step S200 of applying an insulating adhesive to the hollow pipe 131, a step S300 of processing the hollow pipe 131, a step S400 of assembling the fixed pipe 133 with the hollow pipe 131, a step S500 of connecting the conducting wire 139 to the uncoated area 1317 of the hollow pipe through the opening 1331 of the fixed pipe, a step S600 of applying the insulating adhesive to the fixed pipe 133, a step S700 of processing the hollow pipe 131 and the fixed pipe 133, and a step S800 of removing at least a portion of the protrusion 1315 of the hollow pipe.

According to one embodiment, in step S100 of providing the hollow pipe, the hollow pipe 131 may include the plurality of slits 1311 disposed in parallel, the body 1313 on which the plurality of slits is disposed, and the protrusion 1315 extending from the body in at least one of one direction and the other direction opposite to the one direction.

According to one embodiment, in step S100 of providing the hollow pipe, the hollow pipe 131 may be cut to include the plurality of slits 1311 disposed in parallel and the protrusion 1315 extending from the body 1313 in at least one of the one direction and the other direction opposite to the one direction, wherein the plurality of slits is disposed on the body.

According to one embodiment, in step S200 of applying the insulating adhesive to the hollow pipe 131, the insulating adhesive may be applied to a partial area of the hollow pipe 131 to form the uncoated area 1317, the fixed pipe 133 may include the opening 1331, and the uncoated area 1317 and the opening 1331 may be positioned to correspond to each other when assembling the fixed pipe 133.

According to one embodiment, in step S300 of processing the hollow pipe, the hollow pipe 131 may be heat treated between 100 degrees Celsius and 1000 degrees Celsius.

According to one embodiment, in step S400 of assembling the fixed pipe with the hollow pipe, the opening 1331 of the fixed pipe may correspond to the uncoated area 1317 of the hollow pipe 131.

According to one embodiment, in step S500 of connecting the conducting wire to the uncoated area of the hollow pipe through the opening of the fixed pipe, the conducting wire 139 may be connected to the uncoated area 1317 of the hollow pipe by spot welding.

According to one embodiment, in step S600 of applying the insulating adhesive to the fixed pipe, the insulating adhesive may be applied again to the hollow pipe 131 in addition to the fixed pipe 133, or the insulating adhesive may be selectively applied only to the fixed pipe 133 but not the hollow pipe 131.

According to one embodiment, in step S700 of processing the hollow pipe and the fixed pipe, the hollow pipe and the fixed pipe may be heat treated between 100 degrees Celsius and 1000 degrees Celsius.

According to one embodiment, in step S800 of removing at least a portion of the protrusion of the hollow pipe, an end portion of the protrusion in one direction (e.g., the −Z direction) and an end portion of the protrusion in the other direction (e.g., the +Z direction) may be removed. At least a portion of the protrusion 1315 may be removed using laser cutting.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings, and the appended claims. In addition to variations and modifications in the component parts and/or arrangements, alternative uses will also be apparent to those skilled in the art.

What is claimed is:

1. A heater provided in an aerosol-generating device, the heater comprising:
a hollow pipe extending in one direction; and
a fixed pipe surrounding at least a portion of the hollow pipe,
wherein the hollow pipe and the fixed pipe are coupled to each other by an insulating adhesive.

2. The heater of claim 1, wherein the insulating adhesive comprises a ceramic-based material.

3. The heater of claim 1, wherein the hollow pipe comprises:
a plurality of slits disposed in parallel;
a body on which the plurality of slits is disposed; and
a protrusion extending from the body in at least one of the one direction and the other direction opposite to the one direction.

4. The heater of claim 1, further comprising:
a conducting wire connected to the hollow pipe,
wherein the fixed pipe comprises an opening, and
the conducting wire is connected to the hollow pipe through the opening.

5. The heater of claim 1, further comprising:
an insulating pipe surrounding at least a portion of the fixed pipe and spaced apart from the fixed pipe by a gap.

6. The heater of claim 5, wherein the insulating pipe comprises a vacuum space.

7. The heater of claim 1, wherein the fixed pipe comprises an electrically resistive material.

8. A method of manufacturing a heater provided in an aerosol-generating device, the method comprising:
providing a hollow pipe extending in one direction;
applying an insulating adhesive to the hollow pipe;
processing the hollow pipe; and
assembling a fixed pipe with the hollow pipe.

9. The method of claim 8, wherein, in the providing of the hollow pipe, the hollow pipe is provided to include a plurality of slits disposed in parallel, a body on which the plurality of slits is disposed, and a protrusion extending from the body in at least one of the one direction and the other direction opposite to the one direction, and
after assembling the fixed pipe with the hollow pipe, the method further comprises removing at least a portion of the protrusion of the hollow pipe.

10. The method of claim 8, wherein, in the providing of the hollow pipe, the hollow pipe is provided to be cut to include a plurality of slits disposed in parallel and a protrusion extending in at least one of the one direction and the other direction opposite to the one direction from a body on which the plurality of slits is disposed.

11. The method of claim 8, wherein, in the processing of the hollow pipe, the hollow pipe is heat treated between 100 degrees Celsius and 1000 degrees Celsius.

12. The method of claim 8, wherein, in the applying of the insulating adhesive to the hollow pipe, the insulating adhesive is applied to a partial area of the hollow pipe to form an uncoated area,
the fixed pipe comprises an opening, and the uncoated area and the opening are positioned to correspond to each other when assembling the fixed pipe with the hollow pipe, and
after assembling the fixed pipe with the hollow pipe, the method further comprises connecting a conducting wire to the uncoated area of the hollow pipe through the opening of the fixed pipe.

13. The method of claim 8, after assembling the fixed pipe with the hollow pipe, further comprising:
applying the insulating adhesive to the fixed pipe; and
processing the hollow pipe and the fixed pipe.

14. The method of claim 13, wherein, in the processing of the hollow pipe and the fixed pipe, the hollow pipe and the fixed pipe are heat treated between 100 degrees Celsius and 1000 degrees Celsius.

15. An aerosol generating device comprising:
a housing including an insertion space that is open in one direction;
the heater of claim 1;
a controller controlling an operation of the heater; and
a power supply providing power to the heater and the controller.
